(19) United States
(12) Patent Application Publication
(10) Pub. No.: US 2004/0095389 A1
(43) Pub. Date: May 20, 2004

(54) System and method for managing engagements between human users and interactive embodied agents

(76) Inventors: Candace L. Sidner, Newton, MA (US); Christopher H. Lee, Arlington, MA (US)

Correspondence Address: Patent Department, Mitsubishi Electric Research Laboratories, Inc., 201 Broadway, Cambridge, MA, 02139, US

(21) Appl. No.: 10/295,309

(22) Filed: Nov. 15, 2002

(51) Int. Cl. G09G 5/00

(52) U.S. Cl. 345/764

(57) ABSTRACT

A system and method manages an interaction between a user and an interactive embodied agent. An engagement management state machine includes an idle state, a start state, a maintain state, and an end state. A discourse manager is configured to interact with each of the states. An agent controller interacts with the discourse manager and an interactive embodied agent interacting with the agent controller. Interaction data are detected in a scene and the interactive embodied agent transitions from the idle state to the start state based on the interaction data The agent outputs an indication of the transition to the start state and senses interaction evidence in response to the indication. Upon sensing the evidence, the agent transitions from the start state to the maintain state. The interaction evidence is verified according to an agenda. The agent may then transition from the maintain state to the end and then idle state if the interaction evidence fails according to the agenda.

### FIELD OF THE INVENTION

This invention relates generally to man and machine interfaces, and more particularly to architectures, components, and communications for managing interactions between users and interactive embodied agents.

### BACKGROUND OF THE INVENTION

In the prior art, the term agent has generally been used for software processes that perform autonomous tasks on the behalf of users. Embodied agents refer to those agents that have humanistic characteristics, such as 2D avatars and animated characters and 3D physical robots.

Robots, such as those used for manufacturing and remote control, mostly act autonomously or in a preprogrammed manner, with some sensing and reaction to the environment. For example, most robots will cease normal operation and take preventative actions when hostile conditions are sensed in the environment. This is colloquially known as the third law of robotics, see Asimov, Foundation Trilogy, 1952.

Of special interest to the present invention are interactive embodied agents. For example, robots that look, talk and act like living beings. Interactive 2D and 3D agents communicate with users through verbal and non-verbal actions such as body gestures, facial expressions, and gaze control. Understanding gaze is particularly important, because it is well known that “eye-contact” is critical in “managing” effective human interactions. Interactive agents can be used for explaining, training, guiding, answering, and engaging in activities according to user commands, or in some cases, reminding the user to perform actions.

One problem with interactive agents is to “manage” the interaction, see for example, Tojo et al., “A Conversational Robot Utilizing Facial and Body Expression,” IEEE International Conference on Systems, Man and Cybernetics, pp. 858-863, 2000. Management can be done by having the agent speak and point. For example in U.S. Pat. No. 6,384,829, Provost et al. described an animated graphic character that “emotes” in direct response to what is seen and heard by the system.

Another embodied agent was described by Traum et al. in “Embodied Agents for Multi-party Dialogue in Immersive Virtual Worlds, Proceedings of Autonomous Agents and Multi-Agent Systems,” ACM Press, pp. 766-773, 2002. That system attempts to model the attention of 2D agents. While that system considers attention, it does not manage the long term dynamics of the engagement process, where two or more participants in an interaction establish, maintain, and end their perceived connection, such as how to recognize a digression from the dialogue, and what to do about it. Also, they only contemplate interactions with users.

Unfortunately, most prior art systems lack a model of the engagement. They tend to converse and gaze in an ad-hoc manner that is not always consistent with real human interactions. Hence, those systems are perceived as being unrealistic. In addition, the prior art systems generally have only a short-term means of capturing and tracking gestures and utterances. They do not recognize that the process of speaking and gesturing is determined by the perceived connection between all of the participants in the interaction. All of these conditions result in unrealistic attentional behaviors.

Therefore, there is a need for a method in 2D and robotic systems that manages long-term user/agent interactions in a realistic manner by making the engagement process the primary one in an interaction.

### SUMMARY OF THE INVENTION

The invention provides a system and method for managing an interaction between a user and an interactive embodied agent. An engagement management state machine includes an idle state, a start state, a maintain state, and an end state. A discourse manager is configured to interact with each of the states. An agent controller interacts with the discourse manager and an interactive embodied agent interacting with the agent controller.

### BRIEF DESCRIPTION OF THE DRAWINGS

FIG. 1 is a top-level block diagram of a method and system for managing engagements according to the invention;

FIG. 2 is a block diagram of relationships of a robot architecture for interaction with a user; and

FIG. 3 is a block diagram of a discourse modeler used by the invention.

### DETAILED DESCRIPTION OF THE PREFERRED EMBODIMENT

### Introduction

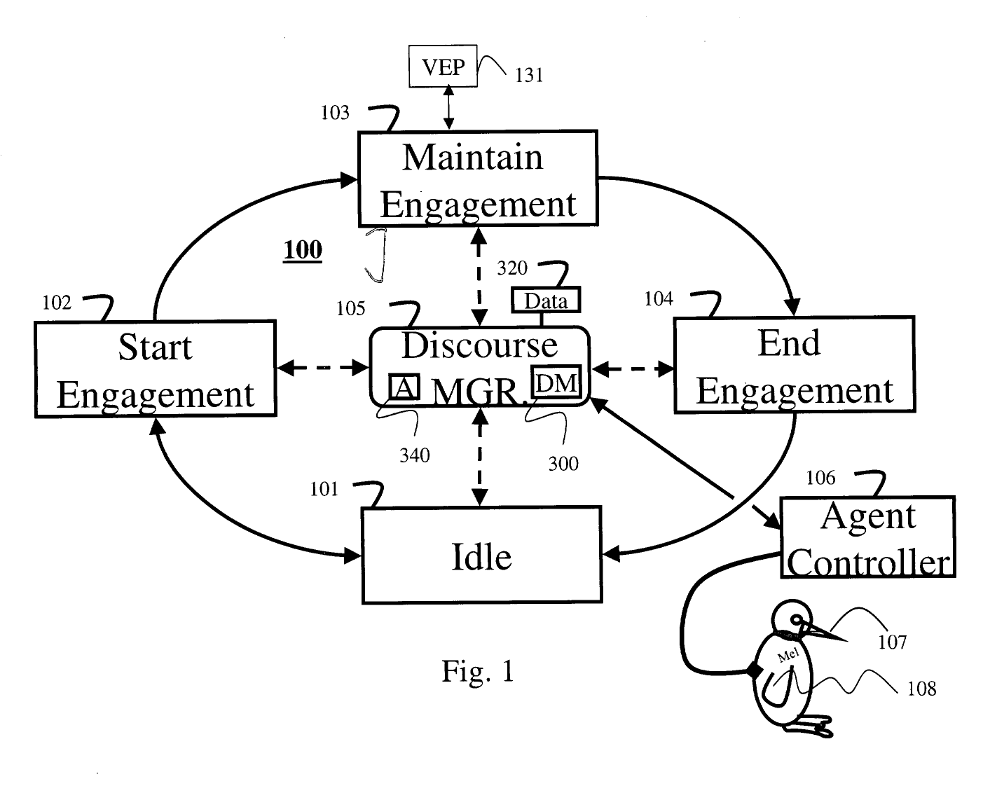

FIG. 1 shows a system and method for managing the engagement process between a user and an interactive embodied agent according to our invention. The system 100 can be viewed, in part, as a state machine with four engagement states 101-104 and a discourse manager 105. The engagement states include idle 101, starting 102, maintaining 103 and ending 104 the engagement. Associated with each state are processes and data. Some of the processes execute as software in a computer system, others are electromechanical processes. It should be understood that the system can concurrently include multiple users, verbal or non-verbal, in the interaction. In addition, it should also be understood that other nearby inanimate objects can become part of the engagement.

The engagement process states 101-104 maintain a “turn” parameter that determines whether the user or the agent is taking a turn in the interaction. This is called a turn in the conversation. This parameter is modified each time the agent takes a turn in the conversation. The parameter is determined by dialogue control of a discourse modeler (DM) 300 of the discourse manager 105.

### Agent

The agent can be a 2D avatar, or a 3D robot. We prefer a robot. In any embodiment, the agent can include one or more cameras to see, microphones to hear, speakers to speak, and moving parts to gesture. For some applications, it may be advantageous for the robot to be mobile and having characteristics of a living creature. However, this is not a requirement. Our robot Mel looks like a penguin 107.

### Discourse Manager

The discourse manager 105 maintains a discourse state of the discourse modeler (DM) 300. The discourse modeler is based on an architecture described by Rich et al. in U.S. Pat. No. 5,819,243 “System with collaborative interface agent,” incorporated herein in its entirety by reference.

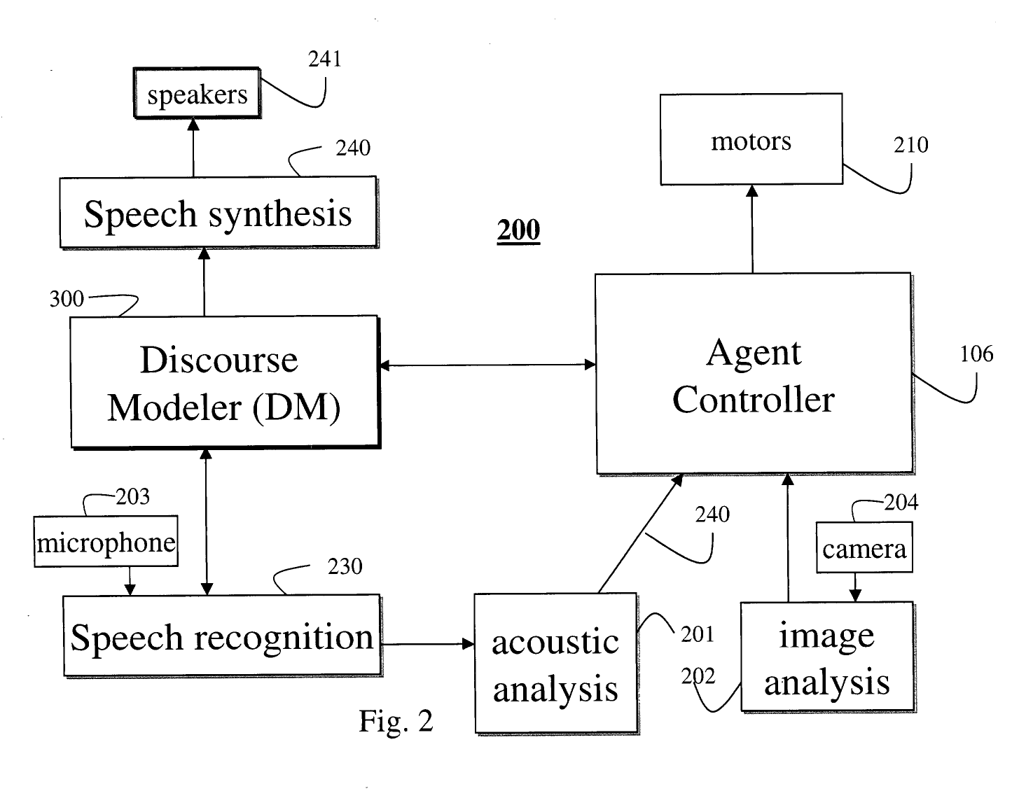

The discourse manager 105 maintains discourse state data 320 for the discourse modeler 300. The data assist in modeling the states of the discourse. By discourse, we mean all actions, both verbal and non-verbal, taken by any participants in the interaction. The discourse manager also uses data from an agent controller 106, e.g., input data from the environment and user via the camera and microphone, see FIG. 2. The data include images of a scene including the participants, and acoustic signals.

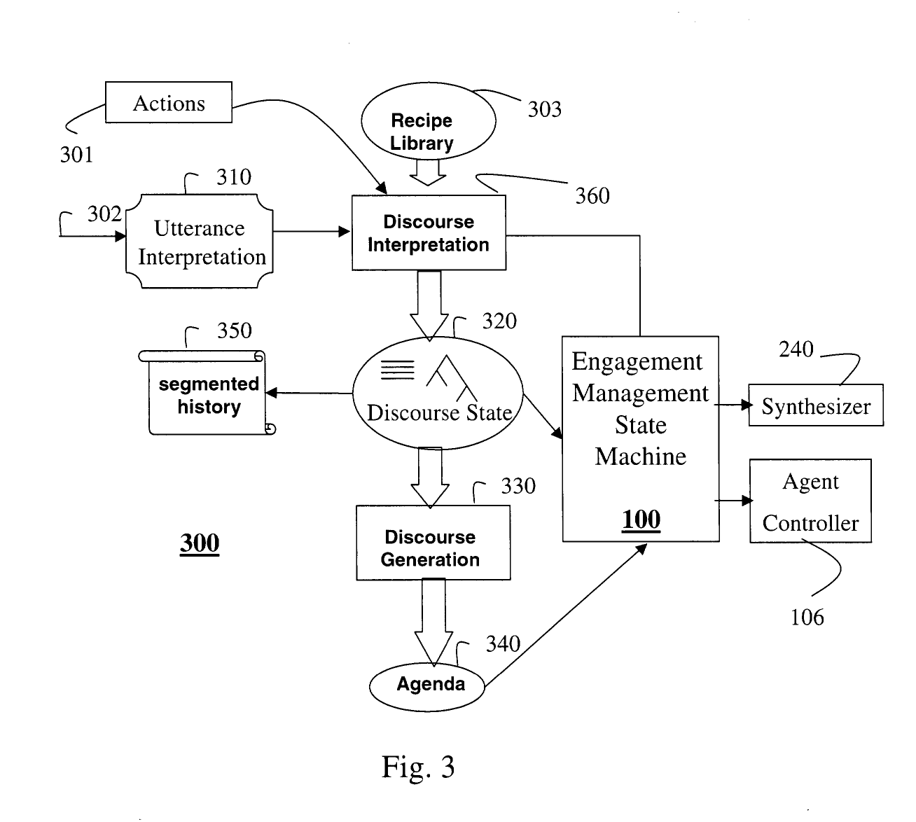

The discourse manager 105 also includes an agenda (A) 340 of verbal and non-verbal actions, and a segmented history 350, see FIG. 3. The segmentation is on the basis of purposes of the interaction as determined by the discourse state. This history, in contrast with most prior art, provides a global context in which the engagement is taking place.

By global, we mean spatial and temporal qualities of the interaction, both those from the gesture and utterances that occur close in time in the interaction, and those gestures and utterances that are linked but are more temporally distant in the interaction. For example, gestures or utterances that signal a potential loss of engagement, even when repaired, provide evidence that later faltering engagements are likely due to a failure of the engagement process. The discourse manager 105 provides the agent controller 106 with data such as gesture, gaze, and pose commands to be performed by the robot.

### System States

### Idle

The idle engagement state 101 is an initial state when the agent controller 106 reports that Mel 107 neither sees nor hears any users. This can be done with known technologies such as image processing and audio processing. The image processing can include face detection, face recognition, gender recognition, object recognition, object localization, object tracking, and so forth. All of these techniques are well known. Comparable techniques for detecting, recognizing, and localizing acoustic sources are similarly available.

Upon receiving data indicating that one or more faces are present in the scene, and that the faces are associated with utterances or greetings, which indicate that the user wishes to engage in an interaction, the idle state 101 completes and transitions to the start state 102.

### Start

The start state 102 determines that an interaction with the user is to begin. The agent has a “turn” during which Mel 107 directs his body at the user, tilts his head, focuses his eyes at the user's face, and utters a greeting or a response to what he has heard to indicate that he is also interested in interacting with the user.

Subsequent state information from the agent controller 106 provides evidence that the user is continuing the interaction with gestures and utterances. Evidence includes the continued presence of the user's face gazing at Mel, and the user taking turns in the conversation. Given such evidence, the process transitions to the maintain engagement state 103. In absence of the user face, the system returns to the idle state 101.

If the system detects that the user is still present, but not looking at Mel 107, then the start engagement process attempts to repair the engagement during the agent's next turn in the conversation. Successful repair transitions the system to the maintain state 103, and failure to the idle state 101.

### Maintain

The maintain engagement state 103 ascertains that the user intends to continue the interaction. This state decides how to respond to user intentions and what actions are appropriate for the robot 107 to take during its turns in the conversation.

Basic maintenance decisions occur when no visually present objects, other than the user, are being discussed. In basic maintenance, at each turn, the maintenance process determines whether the user is paying attention to Mel, using as evidence the continued presence of the user's gaze at Mel, and continued conversation.

If the user continues to be engaged, the maintenance process determines actions to be performed by the robot according to the agenda 340, the current user and, perhaps, the presence of other users. The actions are conversation, gaze, and body actions directed towards the user, and perhaps, other detected users.

The gaze actions are selected based on the length of the conversation actions and an understanding of the long-term history of the engagement. A typical gaze action begins by directing Mel at the user, and perhaps intermittently at other users, when there is sufficient time during Mel's turn. These actions are stored in the discourse state of the discourse modeler and are transmitted to the agent controller 106.

If the user breaks the engagement by gazing away for a certain length of time, or by failing to take a turn to speak, then the maintenance process enacts a verify engagement procedure (VEP) 131. The verify process includes a turn by the robot with verbal and body actions to determine the user's intentions. The robot's verbal actions vary depending on whether previously in the interaction another verify process has occurred.

A successful outcome of the verification process occurs when the user conveys an intention to continue the engagement. If this process is successful, then the agenda 340 is updated to record that the engagement is continuing. A lack of a positive response by the user indicates a failure, and the maintenance process transitions to the end engagement state 104 with parameters to indicate that the engagement was broken prematurely.

### Objects

When objects or “props” in the scene are being discussed during maintenance of the engagement, the maintenance process determines whether Mel should point or gaze at the object, rather than the user. Pointing requires gazing, but when Mel is not pointing, his gaze is dependent upon purposes expressed in the agenda.

During a turn when Mel is pointing at an object, additional actions direct the robot controller to provide information on whether the user's gaze is also directed at the object.

If the user is not gazing at the object, the maintain engagement process uses the robot's next turn to re-direct the user to the object. Continued failure by the user to gaze at the object results in a subsequent turn to verify the engagement.

During the robot's next turn, decisions for directing the robot's gaze at an object under discussion, when the robot is not pointing at the object, can include any of the following. The maintain engagement process decides whether to gaze at the object, the user, or at other users, should they be present. Any of these scenarios requires a global understanding of the history of engagement.

In particular, the robot's gaze is directed at the user when the robot is seeking acknowledgement of a proposal that has been made by the robot. The user return gaze in kind, and utters an acknowledgment, either during the robot's turn or shortly thereafter. This acknowledgement is taken as evidence of a continued interaction, just as it would occur between two human interactors.

When there is no user acknowledgement, the maintain engagement process attempts to re-elicit acknowledgement, or to go on with a next action in the interaction.

Eventually, a continued lack of user acknowledgement, perhaps by a user lack of directed gaze, becomes evidence for undertaking to verify the engagement as discussed above.

If acknowledgement is not required, the maintenance process directs gaze either at the object or the user during its turn. Gaze at the object is preferred when specific features of the object are under discussion as determined by the agenda.

When the robot is not pointing at an object or gazing at the user, the engagement process accepts evidence of the user's conversation or gaze at the object or robot as evidence of continued engagement.

When the user takes a turn, the robot must indicate its intention to continue engagement during that turn. So even though the robot is not talking, it must make evident to the user its connection to the user in their interaction. The maintenance process decides how to convey the robot's intention based on (1) the current direction of the user's gaze, and (2) whether the object under discussion is possessed by the user. The preferred process has Mel gaze at the object when the user gazes at the object, and has Mel gaze at the user when the user gazes at Mel.

Normal transition to the end engagement state 104 occurs when the agenda has been completed or the user conveys an intention to end the interaction.

### End

The end an engagement state 104 brings the engagement to a close. During the robot turn, Mel speaks utterances to pre-close and say good-bye. During pre-closings, the robot's gaze is directed at the user, and perhaps at other present users.

During good-byes, Mel 107 waves his flipper 108 consistent with human good-byes. Following the good-byes, Mel reluctantly turns his body and gaze away from user and shuffles into the idle state 101.

### System Architecture

FIG. 2 shows the relationships between the discourse modeler (DM) 300 and the agent controller 106 according our invention. The figure also shows various components of a 3D physical embodiment. It should be understood, that a 2D avatar or animated character can also be used as the agent 107.

The agent controller 106 maintains state including the robot state, user state, environment state, and other users' state. The controller provides this state to the discourse modeler 300, which then uses it to update the discourse state 320. The robot controller also includes components 201-202 for acoustic and vision (image) analysis coupled to microphones 203 and cameras 204. The acoustic analysis 201 provides user location, speech detection, and, perhaps, user identification.

Image analysis 202, using the camera 204, provides number of faces, face locations, gaze tracking, and body and object detection and location

The controller 106 also operates the robot's motors 210 by taking input from raw data sources, e.g., acoustic and visual, interpreting the data to determine the primary and secondary users, user gaze, object viewed by user, object viewed by the robot, if different, and current possessor of objects in view.

The robot controller deposits all engagement information with the discourse manager. The process states 101-104 can propose actions to be undertaken by the robot controller 106.

The discourse modeler 300 receives input from a speech recognition engine 230 in the form of words recognized in user utterances, and outputs speech using a speech synthesis engine 240 using speakers 241.

The discourse modeler also provides commands to the robot controller, e.g., gaze directions, and various gestures, and the discourse state.

### Discourse Modeler

FIG. 3 shows the structure of the discourse modeler 300. The discourse modeler 300 includes robot actions 301, textual phrases 302 that have been derived from the speech recognizer, an utterance interpreter 310, a recipe library 303, a discourse interpreter 360, a discourse state 320, a discourse generator 330, an agenda 340, a segmented history 350 and the engagement management process, which is described above and is shown in FIG. 1.

Our structure is based on the design of the collaborative agent architecture as described by Rich et al., see above. However, it should be understood that Rich et al. do not contemplate the use of an embodied agent in a much more complex interaction. There, actions are input to a conceration interpretation module. Here, robot actions are an additional type of discourse action. Also, our engagement manager 100 receives direct information about the user and robot in terms of gaze, body stance, object possessed, as well as objects in the domain. This kind of information was not considered or available by Rich et al.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A system for managing an interaction between a user and an interactive embodied agent, comprising;
an engagement management state machine including an idle state, a start state, a maintain state, and an end state;
a discourse manager configured to interact with each of the states;
an agent controller interacting with the discourse manager; and
an interactive embodied agent interacting with the agent controller.

2. A method for managing an interaction with a user by an interactive embodied agent, comprising:
detecting interaction data in a scene;
transitioning from an idle state to a start state based on the data;
outputting an indication of the transition to the start state;
sensing interaction evidence in response to the indication;
transitioning from the start state to a maintain state based on the interaction evidence;
verifying, according to an agenda, the interaction evidence; and
transitioning from the maintain state to the idle state if the interaction evidence fails according to the agenda.

3. The method of claim 2 further comprising:
continuing in the maintain state if the interaction data supports the agenda.
